(19) United States
(12) Patent Application Publication
(10) Pub. No.: US 2014/0260959 A1
(43) Pub. Date: Sep. 18, 2014

(54) WEAR RESISTANT PISTON RING COATING

(71) Applicant: Federal-Mogul Corporation, Southfield, MI (US)

(72) Inventor: James R. Toth, Ann Arbor, MI (US)

(73) Assignee: Federal-Mogul Corporation, Southfield, MI (US)

(21) Appl. No.: 14/208,135

(22) Filed: Mar. 13, 2014

Related U.S. Application Data
(60) Provisional application No. 61/779,425, filed on Mar. 13, 2013.

(51) Int. Cl. F02F 5/00

(52) U.S. Cl. CPC F02F 5/00
USPC 92/172; 29/888.04

(57) ABSTRACT

A method of manufacturing a coated piston ring includes applying a layer of an aluminum-based material to an outside surface of a ring body formed of an iron-based material, such as steel. The layer of an aluminum-based material is applied by thermal spraying. The method further includes an environmentally friendly heat treatment process causing the aluminum-based material to combine with the iron-based material of the ring body and form a wear resistant coating of aluminum iron (Al₅Fe₂). The heat treatment process can include heating to a temperature of about 550° C. for 20 minutes so that the wear resistant coating achieves a hardness of HV 1000.

### CROSS REFERENCE TO RELATED APPLICATION

This application claims the benefit of U.S. provisional application No. 61/779,425 filed Mar. 13, 2013, the entire contents of which is incorporated by reference in its entirety.

### BACKGROUND OF THE INVENTION

1. Field of the Invention

The invention relates generally to piston rings for internal combustion engines, and more particularly to coated piston rings, and methods of manufacturing the coated piston rings.

2. Related Art

A piston of a reciprocating engine, such as an internal combustion engine, typically includes rings disposed in grooves along the outer diameter of the piston. The piston rings facilitate guiding of the piston during reciprocation in a cylinder bore. The piston rings also seal combustion gases and inhibit the upward passage of oil. The piston rings are subject to wear as they move along the cylinder bore due to gas load and their own inherent load. Accordingly, the piston rings are typically coated or treated to enhance wear resistance. For example, the piston rings may be nitrided, coated with chromium, such as hexavalent chromium, or coated with a ceramic. The coatings may be applied to the piston rings by electroplating or by physical vapor deposition (PVD).

### SUMMARY OF THE INVENTION

One aspect of the invention provides a coated piston ring. The piston ring comprises a ring body including an iron-based material extending circumferentially around a center axis. A wear resistant coating is disposed on the ring body and presents an outer diameter surface of the piston ring. The wear resistant coating includes aluminum iron (Al₅Fe₂).

Another aspect of the invention provides a method of manufacturing the coated piston ring. The method includes providing the ring body which includes the iron-based material presenting an outside surface extending circumferentially around the center axis. The method further includes applying a layer of an aluminum-based material to the outside surface of the ring body, and heating the aluminum-based material. The heating step forms the wear resistant coating including aluminum iron (Al₅Fe₂).

The wear resistant coating formed during the heating step has a high hardness, for example HV 1000. Thus, the coated piston ring has a low wear rate when used in a reciprocating engine. The wear rate provided by the wear resistant coating is potentially similar to the wear rate of electroplated chromium coatings. However, unlike the chromium coatings and the electroplating process used to apply the chromium coatings, the wear resistant coating and the method of manufacturing the coated piston ring of the present invention are environmentally green and friendly.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a coated piston ring according to one exemplary embodiment;

FIG. 2 illustrates method steps used to form the coated piston ring according to one exemplary embodiment;

FIG. 3 is a cross-sectional view of an aluminum-based material applied to an outside surface of a ring body used to form the coated piston ring of FIG. 1, prior to a heating step; and

FIG. 4 is a cross-sectional view of a wear resistant coating presenting a plurality of surfaces of a coated piston ring, according to another exemplary embodiment.

### DESCRIPTION OF THE ENABLING EMBODIMENT

One aspect of the invention provides a method of manufacturing a piston ring 20 including a wear resistant coating 22 for reciprocating engine applications, such as internal combustion engine applications. FIG. 1 shows an example of the coated piston ring 20 according to one exemplary embodiment, and FIG. 2 illustrates method steps used to form the coated piston ring 20.

The method begins by providing a ring body 24 formed of an iron-based material, such as steel, steel alloy, cast iron, cast iron alloy, nodular iron, cast steel, or another iron-based material capable of handling the conditions of a reciprocating engine. The ring body 24 extends circumferentially around a center axis A, as shown in FIG. 1. The ring body 24 also presents an outside surface 26, an inside surface 28 facing opposite the outside surface 26, and edge surfaces 30 spacing the outside surface 26 from the inside surface 28, as shown in FIG. 3. In the exemplary embodiment of FIG. 1, the ring body 24 is split such that it presents an opening 32 along each of the surfaces 26, 28, 30. The ring body 24 may be full-face, semi-inlaid, or fully-inlaid. In addition, at least one groove 34, or a plurality of grooves 34, may be formed along the outside surface 26 of the ring body 24.

The method next includes applying a layer 36 of aluminum-based material to the outside surface 26 of the ring body 24, as shown in FIG. 3. The aluminum-based material is typically pure aluminum, but could be an aluminum alloy or another aluminum-based material. The layer 36 of aluminum-based material applied to the outer diameter surface 38 typically has a thickness t₁ of 15 to 25 microns (μm), but could have another thickness t₁.

The process used to apply the aluminum-based material to the outside surface 26 of the ring body 24 is typically a low cost process, such as spraying. In one exemplary embodiment, a plasma spray process is used. This process includes feeding an aluminum wire or aluminum powder into a plasma jet, where the aluminum is melted and then propelled onto the outside surface 26 of the ring body 24. Alternatively, another thermal spray process could be used to apply the layer 36 of aluminum-based material to the outside surface 26. Although not shown in FIG. 3, the layer 36 of aluminum-based material could also be applied to at least a portion of the inside surface 28 and/or at least a portion of the edge surfaces 30 of the ring body 24, in addition to the outside surface 26.

After the layer 36 of aluminum-based material is applied to the outside surface 26, the method includes heating the layer 36 and the ring body 24. The heating step typically includes a heat treatment process causing the layer 36 of aluminum-based material to combine with the iron-based material of the ring body 24 and form aluminum iron (Al₅Fe₂). The aluminum iron (Al₅Fe₂) provides the wear resistant coating 22 of the piston ring 20, as shown in FIGS. 1 and 4. The wear resistant coating 22 can also be referred to as a compound layer or an intermetallic layer. The wear resistant coating 22 typically includes 52 wt. % to 55 wt. % aluminum and 45 wt. % to 48 wt. % iron. In one exemplary embodiment, when the ring body 24 consists of steel and the layer 36 of aluminum-based material is pure aluminum, the wear resistant coating 22 formed during the heating or heat treatment consists essentially of aluminum iron (Al₅Fe₂). However, the exact composition of the wear resistant coating 22 can vary depending on the type of iron-based material and aluminum-based material used. In any event, the majority of the wear resistant coating 22 is aluminum iron (Al₅Fe₂).

The heating step includes heating to a temperature and for a period of time sufficient to form the aluminum iron (Al₅Fe₂). The heating step is typically conducted in an oxygen free, inert atmosphere, such as a nitrogen atmosphere. The time and temperature of the heating step can vary depending on the geometry of the ring body 24 and thickness t₁ of the aluminum layer 36, but in each case, the time and temperature are sufficient to form aluminum iron (Al₅Fe₂). In one exemplary embodiment, the heating step typically includes heating to a temperature of about 550° C. for 20 minutes. The heating step could also include heating until the wear resistant coating 22 has a hardness of HV 1000. The thickness t₂ of the wear resistant coating 22 after the heating step is typically 15 to 50 microns. Although FIG. 4 shows a sharp contrast between the iron-based material of the ring body 24 and the wear resistant coating 22, the iron-based material could gradually transition into the aluminum iron (Al₅Fe₂), and the aluminum-based material could gradually transition to the aluminum iron (Al₅Fe₂), such that the piston ring 20 includes a gradient structure.

Another aspect of the invention provides the coated piston ring 20 including the wear resistant coating 22. The piston ring 20 comprises the ring body 24 including the iron-based material extending circumferentially around the center axis A. The iron-based material typically includes steel, steel alloy, cast iron, cast iron alloy, nodular iron, cast steel, or another iron-based material capable of handling the conditions of a reciprocating engine. In the exemplary embodiment, the ring body 24 is split such that it presents the opening 32 along each of the surfaces 26, 28, 30. The ring body 24 may be full-face, semi-inlaid, or fully-inlaid. The ring body 24 may also present at least one groove 34, or a plurality of grooves 34, along the outside surface 26, as shown in FIG. 1.

The wear resistant coating 22 including the aluminum iron (Al₅Fe₂) provides an outer diameter surface 38 of the piston ring 20, as best shown in FIG. 4. If the aluminum-based material is applied to the edge surfaces 30 of the ring body 24, then the wear resistant coating 22 provides side surfaces 42 of the finished piston ring 20, also shown in FIG. 4. If the aluminum-based material is applied to the inside surface 28 of the ring body 24, then the wear resistant coating 22 also provides an inner diameter surface 40 of the finished piston ring 20, also shown in FIG. 4. The thickness t₂ of the wear resistant coating 22 after the heating step is typically 15 to 50 microns.

However, the iron-based material of the ring body 24 may provide the inner diameter surface of the finished piston ring 20. In this case, the inner diameter surface of the finished piston ring 20 is the same as the inside surface 28 of the ring body 24. The iron-based material of the piston ring 20 may also provide the side surfaces spacing the inner diameter surface from the outer diameter surface 38 of the piston ring 20. In this case, the side surfaces of the finished piston ring 20 are the same as the edge surfaces 30 of the ring body 24.

The wear resistant coating 22 includes aluminum iron (Al₅Fe₂), and preferably consists essentially of aluminum iron (Al₅Fe₂), or consists entirely of aluminum iron (Al₅Fe₂). The wear resistant coating 22 is also referred to as a compound layer or an intermetallic layer. The wear resistant coating 22 typically includes 52 wt. % to 55 wt. % aluminum and 45 wt. % to 48 wt. % iron. In the exemplary embodiment, when the ring body 24 consists of steel and the aluminum-based material is pure aluminum, the wear resistant coating 22 consists of aluminum iron (Al₅Fe₂). However, the exact composition of the wear resistant coating 22 can vary depending on the type of iron-based material and aluminum-based material used. In any event, the majority of the wear resistant coating 22 is aluminum iron (Al₅Fe₂).

The heat treatment step provides the wear resistant coating 22 with a high hardness, which is nominally HV 1000. Thus, the wear rate provided by the wear resistant coating 22 is low and is potentially similar to the wear rate of electroplated chromium coatings. However, unlike the chromium coatings and the electroplating process used to apply the chromium coatings, the wear resistant coating 22 and the process of forming the wear resistant coating 22 of the present invention are environmentally green and friendly.

The coated piston ring 20 is typically disposed in a groove along the outer diameter of a piston (not shown) to facilitate guiding the piston during reciprocation in a cylinder bore (not shown), while also sealing combustion gases and inhibiting the upward passage of oil. The coated piston ring 20 may be disposed adjacent or between other coated piston rings, or uncoated piston rings.

Obviously, many modifications and variations of the present invention are possible in light of the above teachings and may be practiced otherwise than as specifically described while within the scope of the appended claims. In addition, the reference numerals in the claims are merely for convenience and are not to be read in any way as limiting.

What is claimed is:

1. A piston ring, comprising:
a ring body including an iron-based material extending circumferentially around a center axis; and
a wear resistant coating disposed on said ring body and presenting an outer diameter surface of said piston ring, and said wear resistant coating including aluminum iron (Al₅Fe₂).

2. The piston ring of claim 1 wherein said wear resistant coating includes aluminum in an amount of 52 to 55 weight percent (wt. %) and iron in an amount of 45 to 48 wt. %.

3. The piston ring of claim 1 wherein a majority of said wear resistant coating consists of aluminum iron (Al₅Fe₂).

4. The piston ring of claim 1 wherein said wear resistant coating has a hardness of HV 1000.

5. The piston ring of claim 1 wherein said wear resistant coating has a thickness of 15 to 50 microns.

6. The piston ring of claim 1 wherein said wear resistant coating is heat treated.

7. The piston ring of claim 1 wherein said iron-based material includes steel, steel alloy, cast iron, cast iron alloy, nodular iron, or cast steel.

8. The piston ring of claim 1 wherein said iron-based material presents an inside surface of said ring body facing opposite said outer diameter surface.

9. The piston ring of claim 1 wherein said wear resistant coating presents at least a portion of at least one of an inner diameter surface facing opposite said outer diameter surface and side surfaces spacing said inner diameter surface from said outer diameter surface.

10. A method of manufacturing a piston ring, comprising the steps of
providing a ring body including an iron-based material presenting an inside surface and an oppositely facing outside surface each extending circumferentially around a center axis;
applying a layer of an aluminum-based material to the outside surface of the ring body;
heating the aluminum-based material; and
the heating step including forming a wear resistant coating including aluminum iron (Al₅Fe₂).

11. The method of claim 10 wherein the heating step includes heating the aluminum-based material to a temperature of about 550° C. for 20 minutes.

12. The method of claim 10 wherein the heating step is conducted in an oxygen-free, inert atmosphere.

13. The method of claim 10 wherein the step of applying the layer of the aluminum-based material to the outside surface of the ring body includes a thermal spray process.

14. The method of claim 13 wherein the thermal spray process includes plasma spraying.

15. The method of claim 10 wherein the aluminum-based material combines with the iron-based material to form the wear resistant coating during the heating step.

16. The method of claim 10 wherein the step of applying the aluminum-based material to the outside surface of the ring body includes applying the aluminum-based material to a thickness of 15 to 25 microns.

17. The method of claim 10 wherein the wear resistant coating has a hardness of HV 1000.

18. The method of claim 10 wherein the wear resistant coating includes aluminum in an amount of 52 to 55 wt. % and iron in an amount of 45 to 48 wt. %.

19. The method of claim 10 wherein the iron-based material consists of steel, steel alloy, cast iron, cast iron alloy, nodular iron, or cast steel; and the aluminum-based material consists of aluminum

20. The method of claim 10 wherein the ring body includes edge surfaces spacing the inside surface from the outside surface; and applying the aluminum-based material to at least a portion of at least one of the inside surface and the edge surfaces.
